(19) United States
(12) Patent Application Publication
(10) Pub. No.: US 2005/0260044 A1
(43) Pub. Date: Nov. 24, 2005

(54) Filing tool assembly

(76) Inventor: Kun-Chen Chen, Tachia Chen (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/852,490

(22) Filed: May 24, 2004

(51) Int. Cl. B26D 1/12

(52) U.S. Cl. 407/29.15

(57) ABSTRACT

A filing tool assembly has a housing, multiple filing tools and a clamping device. The housing has an opening and is composed of a base and a cover pivotally mounted on the base. The filing tools are pivotally held in the housing at a position near the opening. The clamping device is attached to the housing to keep the cover from pivotal rotation relative to the base. Accordingly, a filing tool assembly versatile in use and convenient in transportation is provided.

### BACKGROUND OF THE INVENTION

1. Field of the Invention

The present invention relates to a filing tool assembly, and more particularly to a filing tool assembly containing multiple files or rasps and which is versatile in use.

2. Description of Related Art

A file or a rasp is a hand tool for filing a surface of an object. However, to file an object to different smoothnesses, different files or rasps are needed. Therefore, a user must carry multiple different files or rasps for different conditions, but to carry multiple files is troublesome to a user.

To overcome the shortcomings, the present invention tends to provide a filing tool assembly to mitigate or obviate the aforementioned problems.

### SUMMARY OF THE INVENTION

The main objective of the invention is to provide a filing tool assembly that contains multiple filing tools and is easily carried and used. The filing tool assembly has a housing, multiple filing tools and a clamping device. The housing has an opening and is composed of a base and a cover pivotally mounted on the base. The filing tools are pivotally held in the housing at a position near the opening. The clamping device is attached to the housing to keep the cover from pivotal rotation relative to the base.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a filing tool assembly in accordance with the present invention;

FIG. 2 is a side plan view of the filing tool assembly in FIG. 1;

FIG. 3 is an enlarged operational side plan view of the filing tool assembly in FIG. 1 showing operation of the clamping device;

FIG. 4 is a perspective view of the filing tool assembly in FIG. 1 showing that one of the filing tools is pivotally rotated to extend out from the opening of the housing;

FIG. 5 is a perspective view of the filing tool assembly in FIG. 1 showing the operation condition of the filing tool assembly;

FIG. 6 is an enlarged plan view in partial cross section of the filing tool assembly in FIG. 1 showing the engagement between the filing tools and the base; and

FIG. 7 is an enlarged plan view in partial cross section of the filing tool assembly in FIG. 1 showing the engagement between the cover and the base.

### DETAILED DESCRIPTION OF PREFERRED EMBODIMENT

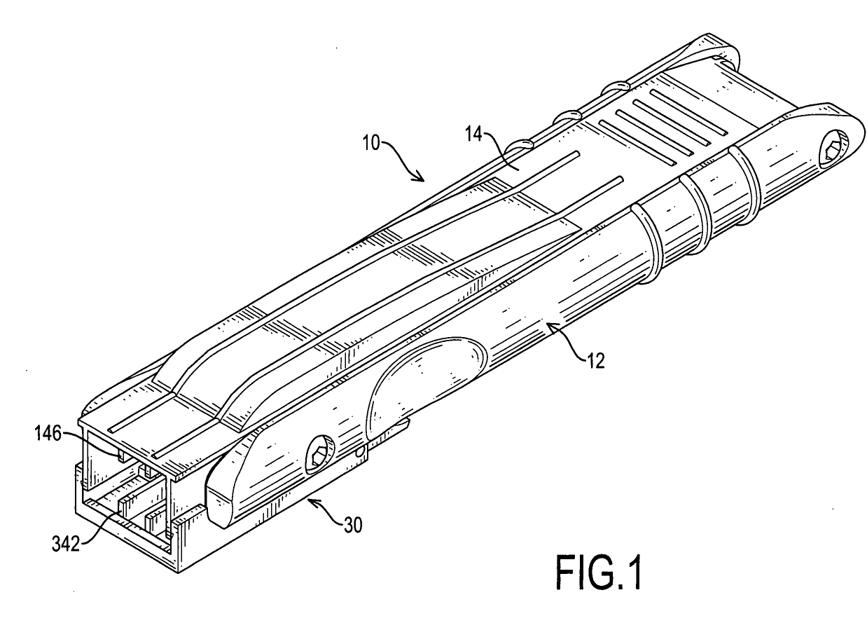

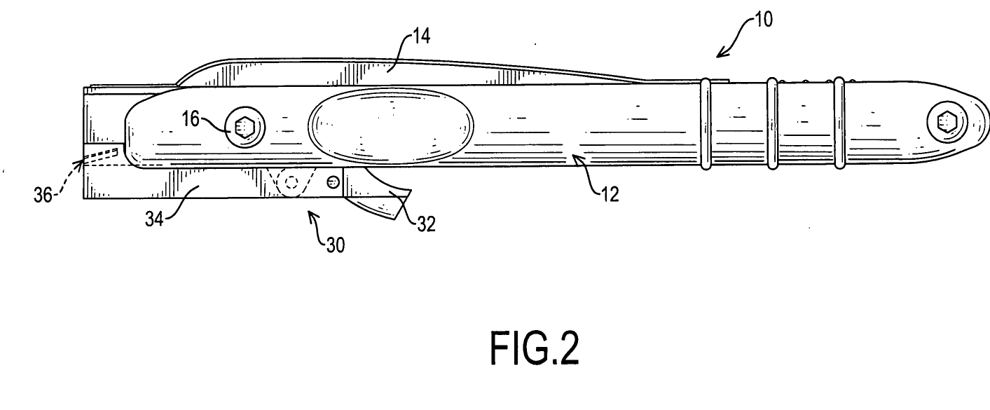

With reference to FIGS. 1, 2 and 4, a filing tool assembly in accordance with the present invention comprises a housing (10), multiple filing tools (20) and a clamping device (30). The housing (10) has an opening and is composed of a base (12) and a cover (14). The base (12) has a chamber (122), a first opening end (124) and a pivotal end (125). The cover (14) is pivotally mounted on the base (12) and has a chamber (141), a second opening end (142) and a pivotal end (144). The pivotal end (144) of the cover (14) is pivotally attached to the pivotal end (125) of the base (12), and the second opening end (142) of the cover (14) corresponds to the first opening end (124) of the base (12) to construct the opening by the opening ends (124, 142).

The filing tools (20) are pivotally held in the housing (10) at a position near the opening. The filing tools (20) have different roughness, shapes or characters to fit with different working conditions. In an operational embodiment, the filing tools (20) are pivotally attached inside the chamber (122) of the base (12) with a pivot (16). The base (12) has at least one partition wall (126) formed in the chamber (122) and corresponding to and located between adjacent filing tools (20) to separate and hold the filing tools (20).

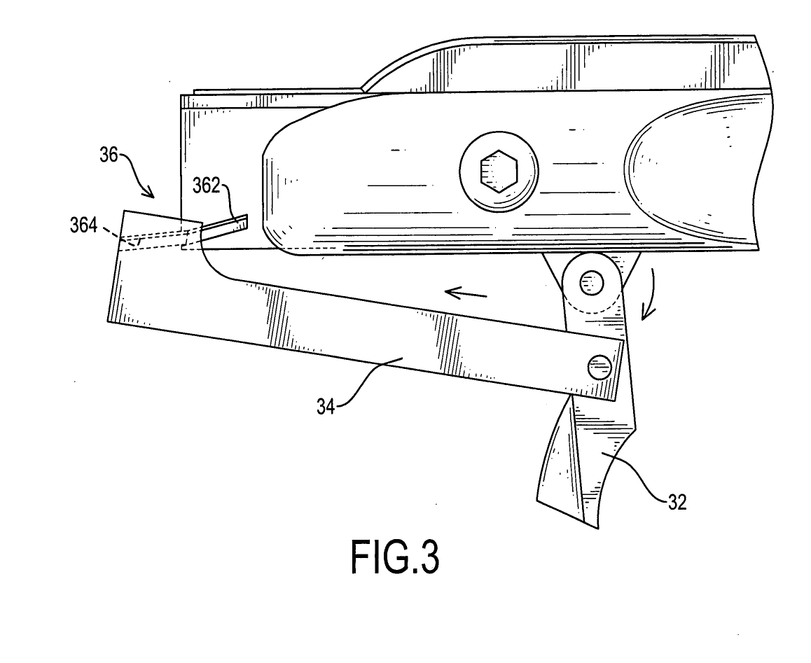

With further reference to FIG. 3, the clamping device (30) is attached to the housing (10) to keep the cover (14) from pivotal rotation relative to the base (12). The clamping device (30) comprises a hand tab (32), a clamping arm (34) and an engaging device (36). The hand tab (32) is pivotally attached to the base (12). The clamping arm (34) has a first end pivotally connected to the hand tab (32) and a second end. The engaging device (36) is mounted between the cover (14) and the second end of the clamping arm (34) to securely hold the second end of the clamping arm (34) onto the cover (14). In an operational embodiment, the engaging device (36) comprises two engaging channels (364) defined in the second end of the clamping arm (34) and two engaging protrusions (362) formed on the cover (14) and engaging respectively with the engaging channels (364) in the clamping arm (34). With the engagement between the engaging protrusions (362) and the engaging channels (364), the cover (14) can be held by the clamping arm (34) and is kept from rotation relative to the base (12).

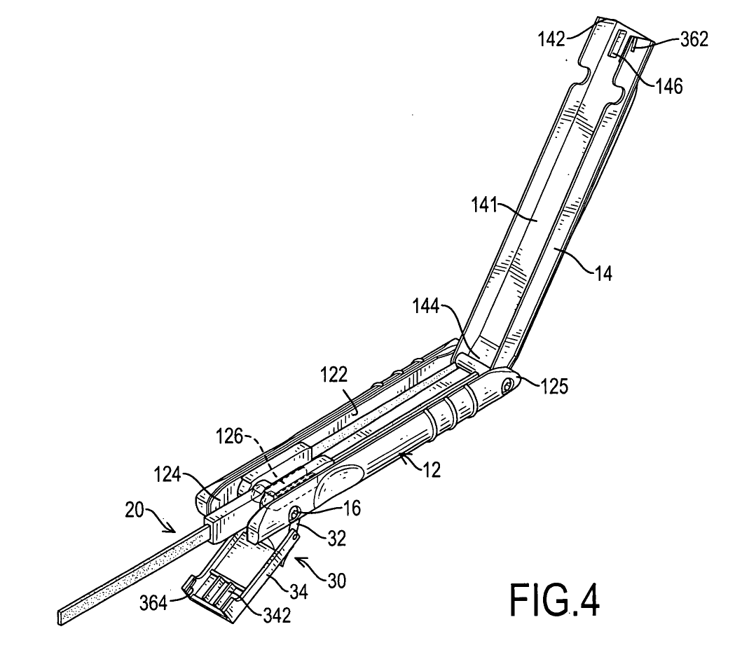

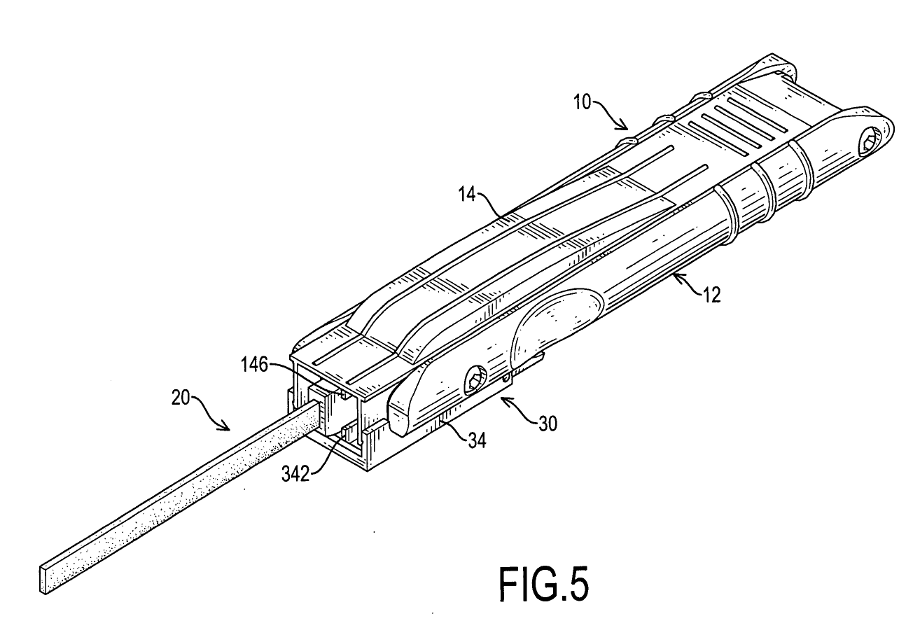

With reference to FIGS. 3 and 4, when the hand tab (32) is pivotally rotated relative to the base (12), the clamping arm (34) will be moved relative to the cover (14). With the movement of the clamping arm (34), the engaging protrusions (362) on the cover (14) will disengage from the engaging channels (364) in the clamping arm (34) and the clamping effect applied to the cover (14) will be released. Consequently, the cover (14) can be pivotally rotated relative to the base (12) to open the chamber (122) in the base (12). After the chamber (122) being opened, one of the filing tools (20) can be rotated to extend out of the chamber (122) in the base (12). Then, the cover (14) is rotated in reverse to close the chamber (122), and engaging channels (364) in the clamping arm (34) are engaged with the engaging protrusions (362) on the cover by means of rotating the hand tab (32). Accordingly, the user can grip the housing (10) as a handle and can file a surface of an object with the exposed filing tool (20) as shown in FIG. 5.

Because multiple filing tools (20) with different characters are mounted in the housing (10), the filing tool assembly can fit with different working conditions by choosing different filing tools (20) to be exposed from the housing (10). Therefore, the filing tool assembly in accordance with the present invention is versatile in use and is convenient to a user in carrying multiple filing tools (20) with different functions.

In addition, the clamping arm (34) further has at least one holding wall (342) corresponding to and located between adjacent filing tools (20) in the housing (10). The cover (14) further has at least one holding wall (146) corresponding to and located between adjacent filing tools (20). The holding walls (146, 342) on the cover (14) and the clamping arm (34) can hold two sides of the exposed filing tool (20). With the arrangement of the holding walls (146, 342), vibration or movement of the filing tool (20) can be prevented when the exposed filing tool (20) is in use.

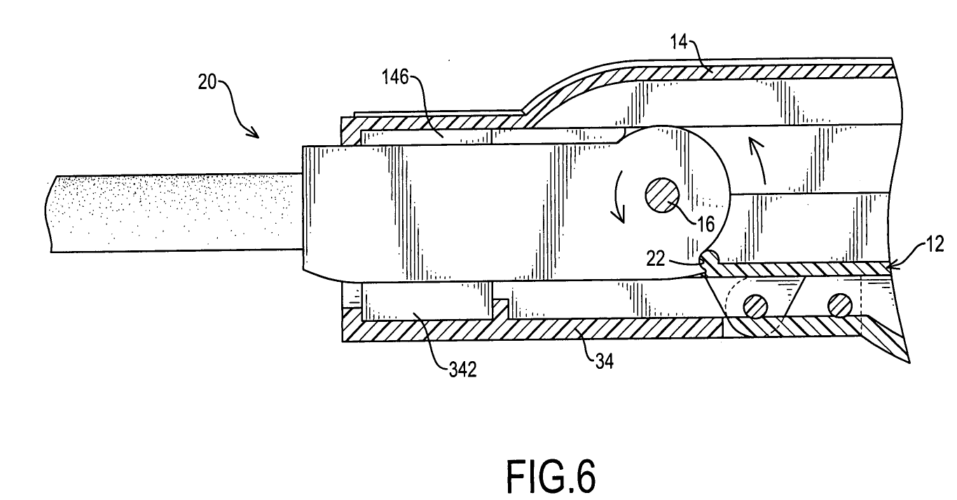

With reference to FIG. 6, each filing tool (20) has a notch (22) defined in one end of the filing tool (20) to engage with the opening end (124) of the base (12). With the engagement between the notch (22) and the opening end (124) of the base (12), the exposed filing tool (20) can be held at a desired position relative to the base (12).

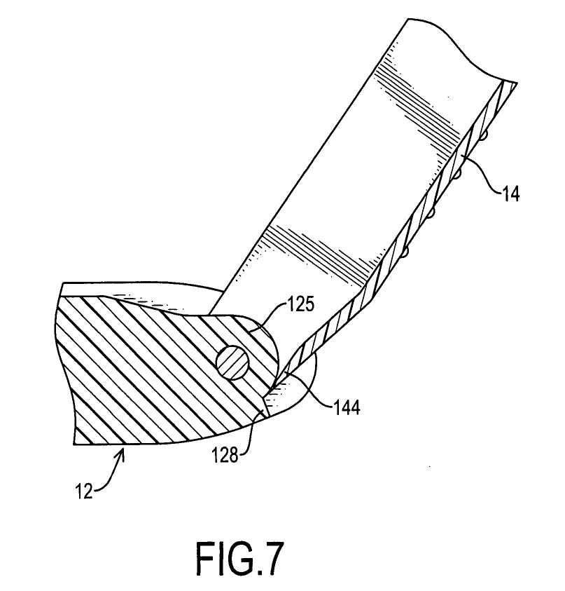

With reference to FIG. 7, a stop (128) protrudes from the pivotal end (125) of the base (12) to abut against the pivotal end (144) of the cover (14) when the cover (14) is opened. With the arrangement of the stop (128), the opening angle of the cover (14) can be limited to a desired range.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A filing tool assembly comprising:
a housing having an opening and composed of
a base;
a cover pivotally mounted on the base
multiple filing tools pivotally held in the housing at a position near the opening; and
a clamping device attached to the housing to keep the cover from pivotal rotation relative to the base.

2. The filing tool assembly as claimed in claim 1, wherein the clamping device comprises
a hand tab pivotally attached to the base;
a clamping arm pivotally connected to the hand tab at a first end of the clamping arm and having a second end; and
an engaging device mounted between the cover and the second end of the clamping arm to securely hold the second end of the clamping arm onto the cover.

3. The filing tool assembly as claimed in claim 2, wherein the engaging device comprises two engaging channels defined in the second end of the clamping arm and two engaging protrusions formed on the cover and engaging respectively with the engaging channels in the clamping arm.

4. The filing tool assembly as claimed in claim 3, wherein the clamping arm further has at least one holding wall corresponding to and located between adjacent filing tools in the housing.

5. The filing tool assembly as claimed in claim 4, wherein the cover further has at least one holding wall corresponding to and located between adjacent filing tools in the housing.

6. The filing tool assembly as claimed in claim 5, wherein the base further has at least one partition wall corresponding to and located between adjacent filing tools.

7. The filing tool assembly as claimed in claim 6, wherein
the base has a chamber, a first opening end and a pivotal end;
the cover has a chamber, a second opening end for constructing the opening in cooperation with the first opening end of the cover and a pivotal end pivotally attached to the pivotal end of the base; and
the filing tools are pivotally mounted in the chamber in the base with a pivot.

8. The filing tool assembly as claimed in claim 7, wherein each filing tool has a notch defined in one end of the filing tool to engage with the opening end of the base.

9. The filing tool assembly as claimed in claim 8, wherein the base has a stop protruding from the pivotal end of the base to abut against the pivotal end of the cover when the cover is opened.

10. The filing tool assembly as claimed in claim 1, wherein
the base has a chamber, a first opening end and a pivotal end;
the cover has a chamber, a second opening end for constructing the opening in cooperation with the first opening end of the cover and a pivotal end pivotally attached to the pivotal end of the base; and
the filing tools are pivotally mounted in the chamber in the base with a pivot.

11. The filing tool assembly as claimed in claim 10, wherein each filing tool has a notch defined in one end of the filing tool to engage with the opening end of the base.

12. The filing tool assembly as claimed in claim 10, wherein the base has a stop protruding from the pivotal end of the base to abut against the pivotal end of the cover when the cover is opened.

13. The filing tool assembly as claimed in claim 10, wherein the cover further has at least one holding wall corresponding to and located between adjacent filing tools.

14. The filing tool assembly as claimed in claim 10, wherein the base further has at least one partition wall corresponding to and located between adjacent filing tools.
